(19) United States
(12) Patent Application Publication
(10) Pub. No.: US 2010/0110313 A1
(43) Pub. Date: May 6, 2010

(54) ELECTRONIC PICTURE FRAME AND METHOD OF OPERATION OF THE SAME

(76) Inventors: Andrew Souders, Oakton, VA (US); Thomas Hoffman, Leesburg, VA (US)

Correspondence Address: POSZ LAW GROUP, PLC, 12040 SOUTH LAKES DRIVE, SUITE 101, RESTON, VA, 20191, US

(21) Appl. No.: 12/263,146

(22) Filed: Oct. 31, 2008

(51) Int. Cl. H04N 5/64; H04M 1/00

(52) U.S. Cl. 348/836; 455/556.1; 348/E05.128

(57) ABSTRACT

An electronic picture frame is provided. The electronic picture frame includes a controller configured to control operation of the electronic picture frame; a memory element configured to store current image data and current operational instructions; a display element configured to display the current image data in accordance with the current operational instructions; and a remote wireless network interface configured to wirelessly connect the controller to a remote network that extends beyond five hundred yards from the electronic picture frame.

### TECHNICAL FIELD

The technical field relates in general to electronic picture frames. More particularly it relates to electronic picture frames connected to wireless networks.

### BACKGROUND

Traditionally, picture frames have been static, holding only a single, physical picture, which can only be altered by physically opening up the frame and changing out the picture for a different one.

In recent years, however, electronic picture frames (sometimes called digital picture frames) have been introduced, which allow one or more digital images to be stored on a local memory element and displayed on an electronic display element (e.g., an LCD display). Such electronic picture frames can be programmed to display a single stored image or to rotate through displaying a number of stored images. Some electronic picture frames might also include video images or audio clips.

However, while they can contain multiple images, it is still necessary to make some effort to change the stored pictures in an electronic picture frame. Typically this involves either connecting a local computer to the digital picture frame and moving images to or from the electronic picture frame using the computer to control the operation, or physically exchanging a non-volatile memory element, such as a secure digital (SD) memory card, located in the electronic picture frame.

In either case, this involves the physical proximity of someone with both the image data and a certain amount of technical skill. In the case of a local connection, someone must connect the local computer to the electronic picture frame and manipulate image files to move them from the computer to the electronic picture frame or vice versa. In the case of swapping out memory cards, someone must load image data onto the memory card (locally or remotely) and then physically swap out the current memory card for the new memory card.

In many cases this will not be a large burden. But in other cases it will. Many people who might desire an electronic picture frame may not have the technical expertise to manipulate images on to or off of the electronic picture frame's memory. Such people must rely upon others to perform the necessary data manipulations. However, these others may not live close to the owner of the electronic picture frame, or may otherwise be unable to change image data very often.

For example, the owner of the electronic picture frame may be elderly grandparents who desire image data of their grandchildren, but lack the technical expertise to operate the electronic picture frame. These grandparents may rely upon one of their children to update the image data. However, for a variety of reasons, it may not be easy for the children to update the image data very often. Perhaps they live far away from the grandparents and can't visit very often. Or perhaps it is cumbersome to bring their computer close to the electronic picture frame to make the necessary changes.

As a result, it is often the case that electronic picture frames are loaded with a set of pictures, but then are rarely, or never, updated with new pictures because of the difficulty in doing so. This can significantly reduce the usefulness and appeal of the electronic picture frame by effectively reducing it to displaying one, or a small number, of pictures.

It would therefore be desirable to provide an electronic picture frame that can have its contents altered remotely by a trusted source.

### SUMMARY

Accordingly, one or more embodiments provide an electronic picture frame, comprising: a controller configured to control operation of the electronic picture frame; a memory element configured to store current image data and current operational instructions; a display element configured to display the current image data in accordance with the current operational instructions; and a remote wireless network interface configured to wirelessly connect the controller to a remote network that extends beyond five hundred yards from the electronic picture frame. The remote network may be a cellular telephone network, or may be the Internet.

The controller may be further configured to perform an authentication operation to authenticate a remote device contacted over the remote network. The authentication operation may be performed by contacting a remote trusted authorization source via the remote network. The authentication operation may be performed using a public-private encryption key pair.

The controller may be further configured to receive at least one of new digital multimedia data, new operational instructions, and new information related to a core operating functionality of the controller from the remote device contacted over the remote network, via the remote network interface, and to store the at least one of the new digital multimedia data, the new operational instructions, and the new information related to the core operating functionality of the controller, to replace at least one of current digital multimedia data, current operational instructions, and current information related to the core operating functionality of the controller.

A method is also provided of operating a local electronic picture frame. This method comprises: providing the local electronic picture frame with encryption information; wirelessly receiving a communication request from a remote device through a remote network; authenticating the remote device based on the encryption information; wirelessly receiving update information from the remote device through the remote network, if the authenticating of the remote device is successful; and performing an invalid request operation, if the authenticating of the remote device is not successful.

The update information may include new image data. And the method may further comprise: storing the new image data in a memory element; and displaying the new image data on a display element.

The update information may include operational instructions. And the method may further comprise: storing the operational instructions in a memory element; and displaying image data on a display element based on the operational instructions.

The update information may include instructions to delete old image data. And the method may further comprise: deleting the old image data from a memory element in accordance with the instructions to delete; and displaying remaining image data from the memory element on a display element.

The invalid request operation may include at least one of: storing information regarding the remote device in a memory element, and notifying a user of the local electronic picture frame of the unsuccessful authenticating of the remote device.

The authenticating of the remote device may be performed by having the local electronic picture frame wirelessly contact a remote trusted source through the remote network, the remote trusted source performing an authentication procedure based on the encryption information. The encryption information may be a public-private encryption key pair.

The remote network may be a cellular telephone network or the Internet.

Another method is also provided of operating a local electronic picture frame. This method comprises: receiving picture frame update information; receiving encryption information; wirelessly sending a communication request to a remote electronic picture frame through a remote network; wirelessly receiving an authentication message from the remote electronic picture frame through the remote network; and wirelessly sending the frame update information to the remote electronic picture frame through the remote network after receiving the authentication message.

The picture frame update information may include at least one of: new image data, operational instructions, and instructions to delete old image data. The encryption information may be a public-private encryption key pair.

The remote network may be a cellular telephone network or the Internet.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a block diagram showing an electronic picture frame system according to disclosed embodiments;

FIG. 2 is a flow chart showing a process of a remote device updating image data in a local electronic picture frame according to disclosed embodiments;

FIG. 3 is a flow chart showing a process of image and operational data in a local electronic picture frame being updated by a remote device according to disclosed embodiments; and

FIG. 4 is a flow chart showing a process of a local electronic picture frame updating a remote electronic picture frame according to alternate disclosed embodiments.

### DETAILED DESCRIPTION

In overview, the present disclosure concerns electronic picture frames. More specifically, it relates to an electronic picture frame, and method of operating the same, in which the electronic picture frame can be remotely updated by a trusted remote source.

The instant disclosure is provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring principles and concepts, further discussion of such software and ICs, if any, will be limited to the essentials with respect to the principles and concepts used by the exemplary embodiments.

Digital Picture Frame System

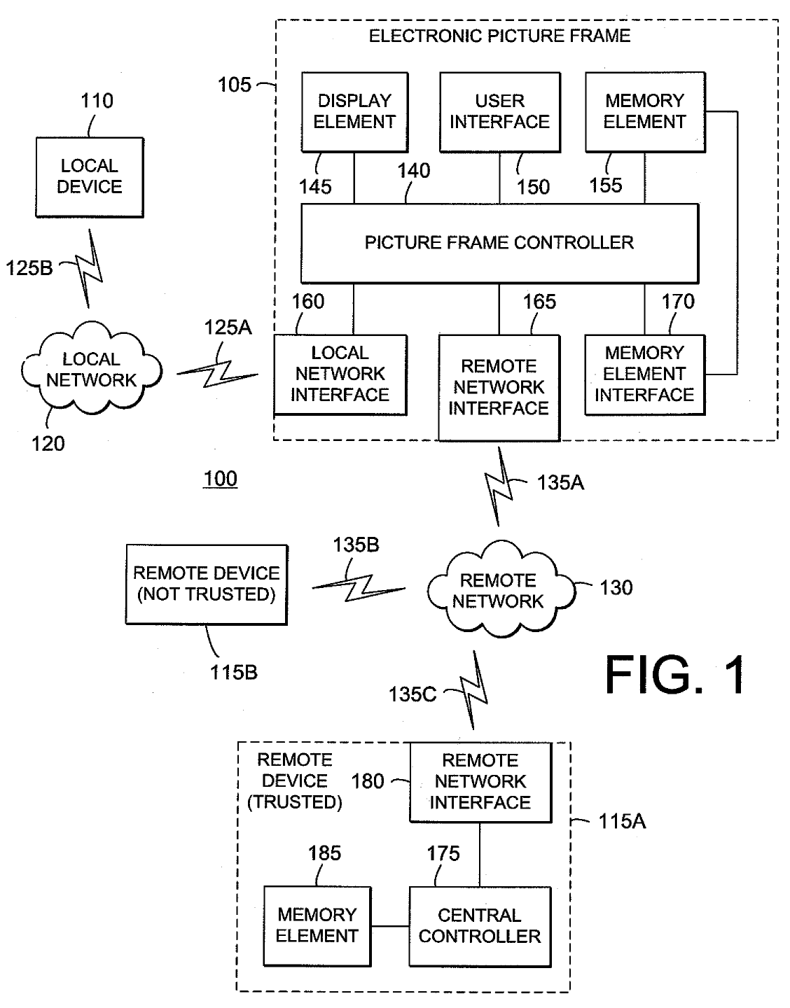

FIG. 1 is a block diagram showing an electronic picture frame system 100 according to disclosed embodiments. As shown in FIG. 1, the exemplary electronic picture frame system includes an electronic picture frame 105, a local device 110, and two remote devices 115A and 115B. The electronic picture frame 105 is connected to the local device 110 through a local network 120 via local network connections 125A and 125B. The electronic picture frame 105 is connected to the remote devices 115 through a remote network 130 via remote network connections 135A, 135B, and 135C. The electronic picture frame 105 includes a picture frame controller 140, a display element 145, a user interface 150, a memory element 155, a local network interface 160, a remote network interface 165, and a memory element interface 170. One of the remote devices 115A is a trusted source. It includes a central controller 175, a remote network interface 180. and a memory element 185.

The electronic picture frame 105 is configured so that it may connect to both the local network 120 and the remote network 130. As a result, its operation to be controlled either by signals received locally or by signals received remotely.

The local device 110 can be any sort of device that might connect to a local network 120, such as a computer, a camera, a personal digital assistant, a telephone, or the like. In various embodiments, the local device can be configured such that it can control the content or the operation of the electronic picture frame 105.

The local network 120 is a short range network that connects the electronic picture frame 105 to the local device 11O. It may be a permanent network, such as a local area network (LAN) or a personal area network (PAN), or a temporary network, such as a connection wire plugged into the electronic picture frame 105 and the local device 110. It can also be a wireless connection or a wired connection. As a result, the local network connections 125A and 125B can either be wired or wireless connections. In some embodiments the local network 120 can include multiple networks (e.g., a wireless and a wired network). In this case, the local network connections 125A and 125B can include multiple connectors as needed.

The remote device 115A is a trusted source that is known to the electronic picture frame 105 and can authenticate other remote devices. For example, it could be a known centralized authorization source that can perform an authorization function for remote devices.

The remote device 115B is any device that is connected to the local network and desires to alter the data or control operations of the electronic picture frame 105. In the disclosed embodiments, the remote device 115B is not a trusted source, and so must be verified before it can be granted permission to alter the contents or operability of the electronic picture frame 105. In various embodiments the remote device 115B could be a computer, a cellular telephone, a remote electronic picture frame, or any device that might have the capability of providing data or instructions to the electronic picture frame 105.

The remote network 130 is a long range network (e.g., one that extends beyond 500 that connects the electronic picture frame 105) to the remote devices 115. It may be a cellular telephone network, the Internet, a wide area network (WAN), or any suitable long-range network.

The remote network connections 135A, 135B, and 135C are any suitable wired or wireless connection between the electronic picture frame and the remote network 130 and the remote devices 115 and the remote network 130. If the remote network 130 is a cellular telephone network, the remote network connections 135A, 135B, and 135C would be cellular telephone connections. If the remote network 130 is the Internet, then these connections could be physical or wireless connections to the Internet.

In the electronic picture frame 105, the picture frame controller 140 serves to control the operation of the electronic picture frame 105. It can be a microprocessor or other suitable electronic control element. Although not specifically shown in FIG. 1, the picture frame controller 140 may include a communications bus allowing all of the various elements in the electronic picture frame 105 to communicate with each other.

The display element 145 is the part of the electronic picture frame 105 that displays the stored data. This can be a liquid crystal display, a plasma display, or any suitable element for displaying image data. In alternate embodiments in which the stored data includes video data, audio data, or text data, the display element will include the capability to properly output the stored data. For example, it may include a speaker if audio data is to be part of the stored data; it may include a display screen suitable for displaying moving video if video data is to be part of the stored data; and it may include a text display element (e.g., a text screen) if text data is to be included in the stored data.

The user interface 150 allows a user at the electronic picture frame 105 to manipulate the data stored in the electronic picture frame 105. For example, this may include a set of buttons that can control which data is displayed (e.g., selecting a single image/video/sound or multiple images/videos/sounds), how the data is displayed (e.g., in a slide show, as a static image, etc.), whether the electronic picture frame 105 is on or off, etc. In other embodiments the user interface 150 can be implemented in whole or in part coincident with the display element by having the display element operate as a touch screen.

The memory element 155 contains the stored data for display. It is preferably a non-volatile memory (e.g., SRAM, flash memory, etc.) of sufficient size to include multiple images, videos, or audio clips. In different embodiments it may be a fixed memory, integral to the electronic picture frame 105, or a removable memory such as a memory card or a memory stick.

The local network interface 160 includes the circuitry necessary to connect the electronic picture frame 105 to the local network 120. In some embodiments this can be a circuit for connecting to a single physical cable (e.g., a Firewire cable, a USB cable, and Ethernet cable, etc.); in other embodiments it can be a circuit for connecting to a wireless network (e.g., a Bluetooth network, an IEEE 802.11 network, etc.); in still other embodiments it can include multiple interface circuits to connect to multiple possible wired or wireless connections.

The remote network interface 165 includes the circuitry necessary to connect the electronic picture frame 105 to the remote network 130. In some embodiments this can be a circuit for connecting to a single physical cable (e.g., an Ethernet cable to connect to the Internet); in other embodiments it can be a circuit for connecting to a wireless network (e.g., a cellular telephone network or a WAN); in still other embodiments it can include multiple interface circuits to connect to multiple possible wired or wireless connections.

The memory element interface 170 provides the necessary circuitry to connect the memory element to the electronic picture frame 105. For example, if the memory element 155 is a removable memory element (e.g., an SD memory card, a memory stick, or the like), the memory element interface 170 can include the slot that the memory element 155 slides into and the connections allowing data to pass from the memory element 155 to the display element 145.

In the remote device 115A (i.e., the trusted source), the central controller 175 controls the operation of the remote device 115A. In various embodiments, the central controller 175 can include a microprocessor, or the like. Although not shown, the central controller can also include a data bus to allow the elements in the remote device 115A to communicate with each other.

In the disclosed embodiments, the central controller 175 is configured to perform authentication operations for other remote devices 115B (i.e., non-trusted devices) with respect to a given electronic picture frame 105. In other words, when a non-trusted remote device 115B attempts to contact the electronic picture frame 105 and add, remove, or alter data, the electronic picture frame 105 can call the trusted remote device 115A to verify the that non-trusted remote device is authorized to do so. This authentication process can be performed using authentication information stored in the memory element 185.

The remote network interface 180 includes the circuitry necessary to connect the trusted remote device 115A to the remote network 130. In some embodiments this can be a circuit for connecting to a single physical cable (e.g., an Ethernet cable to connect to the Internet); in other embodiments it can be a circuit for connecting to a wireless network (e.g., a cellular telephone network or a WAN); in still other embodiments it can include multiple interface circuits to connect to multiple possible wired or wireless connections.

The memory element 185 contains the authentication information necessary to perform authentication operations with respect to non-trusted remote devices. It can include information with respect to public-private encryption key pairs, or any other appropriate encryption data or authentication information.

Although not shown, each of the devices 105, 110, 115A, and 115B will also each have a power supply of some sort. This can be a battery power supply, a plug to an external power supply, or any sort of element that can provide the necessary power to the devices.

In various embodiments, the local network 120 and the remote network 130 can each be temporary or permanent, and can each be wired or wireless. For example the local network 120 could be a permanent wireless network (e.g., an 802.11 wireless network maintained by a server or a router), an ad hoc wireless network (e.g., a wireless Bluetooth network connection to allow a camera to download pictures), a permanent wired network (e.g., an Ethernet connection connecting the electronic picture frame 105 to a computer), a temporary network connection (e.g., a USB or Firewire cable connecting the electronic picture frame 105 to a camera or a computer). In addition, the remote network 130 could be a permanent wired network (e.g., an Internet connection maintained by a wired router connected to the electronic picture frame 105), a permanent wireless network (e.g., an Internet connection maintained by a wireless router), a temporary wired connection (e.g., a wired telephone connected to the electronic picture frame 105), or a temporary wireless connection (e.g., a cellular telephone circuit that can contact remote devices as needed using a cellular network).

Remotely Updating an Electronic Picture Frame

In an effort to increase security in an electronic picture frame, it will generally be desirable to limit the ability of remote devices to alter the contents or operation of the electronic picture frame without authentication. In this way, only those devices that can be authenticated by an electronic picture frame will be able to make changes to the contents of the electronic picture frame. This authentication requirement will limit the ability of unauthorized operators from making malicious or inadvertent changes to the contents or instructions in the electronic picture frame.

As noted above, one way to provide for authentication is to set up a known and trusted remote authentication device that can be used by the electronic picture frame to authenticate any remote devices that wish to update its contents. This way, the electronic picture frame need never give any information to the remote device until the device is authenticated by the trusted authentication device.

Another way to provide for authentication is to allow the remote device to directly contact the electronic picture frame, but to use a public-private key pair for authentication. In this way, the user of the electronic picture frame and the user of the remote device can exchange their public keys by a secure manner (e.g., by an in-person meeting) and then use public-private key encryption these for later remote authentication.

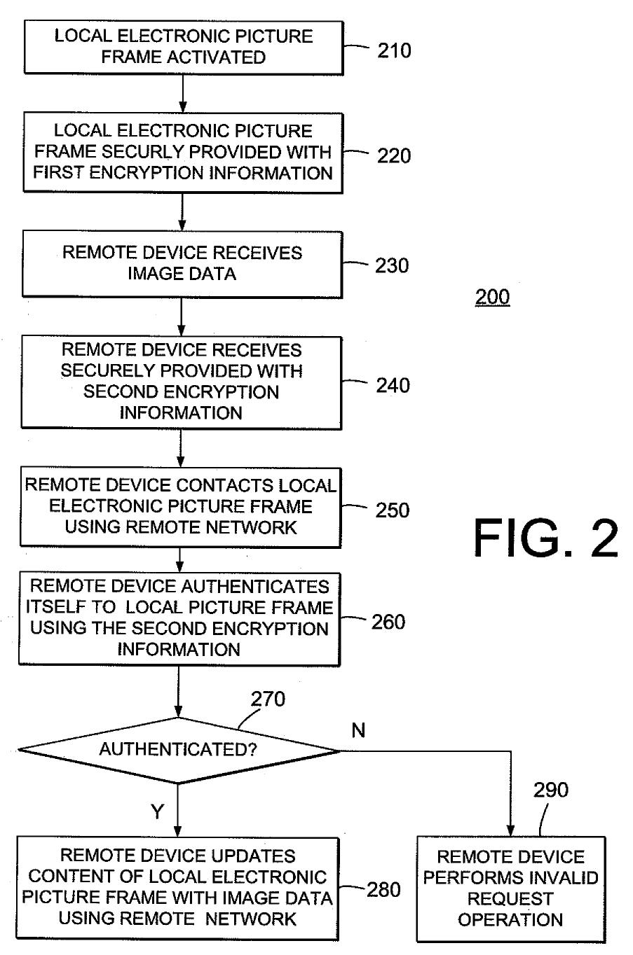

FIG. 2 is a flow chart showing a process of a remote device updating image data in a local electronic picture frame according to disclosed embodiments. As shown in FIG. 2, the process 200 begins when a local electronic picture frame is activated (210).

Once it is activated, the local electronic picture frame is provided with first encryption information in a secure manner (220). This can be accomplished by physically entering first encryption information into the local electronic picture frame from a secure source (e.g., a known user in the same physical location), by contacting a known and trusted remote location (e.g., a secure authentication server), or any other method of securely obtaining the first encryption information.

Meanwhile, a remote device receives image data (230) and is securely provided with second encryption information (240). Although this operation refers to “image data,” the data can actually include static image data, video image data, audio data, or anything else that could be displayed at a local or remote electronic picture frame.

As with the first encryption information, the second encryption information can be securely obtained by physically entering the second encryption information into the remote electronic picture frame from a secure source (e.g., a known user in the same physical location), by contacting a known and trusted remote location (e.g., a secure authentication server), or any other method of securely obtaining the first encryption information.

The first and second encryption information can be any sort of encryption information that will allow the local electronic picture frame to authenticate the remote device. This may include public-private key pairs, passwords, or any other sort of encryption information that would serve this purpose.

Once the local electronic picture frame has been set up, the remote device has received the image data, and both the local electronic picture frame and the remote device have securely received their respective encryption information, the remote device contacts the local electronic picture frame (250) and attempts to authenticate itself to the local electronic picture frame using the second encryption information (260).

The local electronic picture frame will then use the first and second encryption information to authenticate the remote device. And based on this authentication operation, the local electronic picture frame informs the remote device as to whether the authentication process was successful (270). This can occur by the local electronic picture frame sending a communication to the remote device directly indicating either success or failure. Alternatively, if authentication fails, the local electronic picture frame may inform the remote device of the failure by simply failing to acknowledge successful authentication within a certain amount of time.

If the authentication is not successful, then the remote device performs some sort of invalid request operation (280). This can include storing information regarding the authentication failure in a memory element, displaying information regarding the authentication failure on a display element, or the like. This invalid request operation may also provide the user of the remote device with reasons for the failure to authenticate, and may offer an opportunity to correct these errors and reauthenticate. For example, the failure to authenticate may have been due to incorrectly entered encryption information. And the user of the remote device may be prompted to check the accuracy of the encryption information and try again.

In the case of correction reauthentication, the remote device could return to the operations of contacting the local electronic picture frame (250) and providing encryption information (260) after an invalid request operation is performed.

If the authentication operation is successful, however, then the remote device updates the contents of the local electronic picture frame with the image data over the remote network (280).

In performing this operation, a remote device can update the image information in a local electronic picture frame without any additional action by the user of the local electronic picture frame beyond turning the local electronic picture frame on and making certain that the local electronic picture frame has the necessary encryption information. And since these two operations need only be performed once, this will typically be no great burden to accomplish. As a result, a skilled user could set up the local electronic picture frame in person for a less skilled user. Then the skilled user could remotely update the image information in the local electronic picture frame from a remote location, increasing the ease and efficiency of the operation, and allowing it to be performed more easily and thus possibly more often.

Updating Digital Picture Frame Remotely

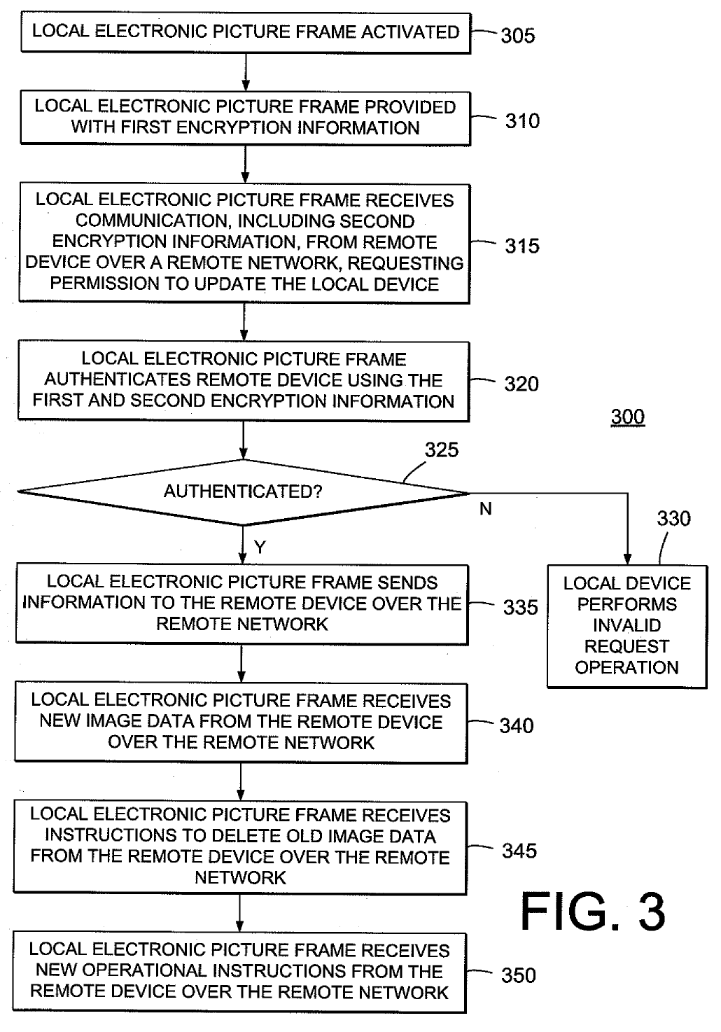

FIG. 3 is a flow chart showing a process of image and operational data in a local electronic picture frame being updated by a remote device according to disclosed embodiments.

As shown in FIG. 3, the process 300 begins when the local electronic picture frame is activated (305).

Once it is activated, the local electronic picture frame is provided with first encryption information in a secure manner (310). This can be accomplished by physically entering first encryption information into the local electronic picture frame from a secure source (e.g., a known user in the same physical location), by contacting a known and trusted remote location (e.g., a secure authentication server), or any other method of securely obtaining the first encryption information.

The local electronic picture frame then receives a communication, including second encryption information, from a remote device over a remote network, requesting permission to update the local device (315). The remote device might be a computer, a cellular telephone, a personal digital assistant, or even another electronic picture frame. The remote network could be a wired telephone network, a wireless telephone network, the Internet, a wide area network (WAN), or the like.

Having received the request for update, the local electronic picture frame then proceeds to authenticate the remote device using the first and second encryption information (320, 325). This can involve comparing passwords, authenticating using a public-private key pair, or any other authentication process that relies upon some sort of secure encryption information.

If the authentication is not successful, then the local electronic picture frame performs some sort of invalid request operation (330). This can include storing information regarding the authentication failure in a memory element, displaying information regarding the authentication failure on a display element, warning a user that an unsuccessful attempt to alter the content of the local electronic picture frame was attempted, or the like.

If the authentication operation is successful, however, then the local device sends information to the remote device over the remote network (335). This information can include current image data stored in the local electronic picture frame, current operational instructions stored in the local electronic picture frame, routing information, information relating to the physical parameters of the remote electronic picture frame, or the like.

The local electronic picture frame can then receive new image data from the remote device over the remote network (340), instructions to delete old image data (i.e., currently stored image data) from the remote device over the remote network (345), or new operational instructions from the remote device over the remote network (350).

Although this operation discloses the remote device updating the local electronic picture frame with ‘image data,’ this image data can include data relating to still images, video, or audio. The operational instructions can include information as to how to display the image data, when to display the image data, how to cycle through displaying the image data, captions to provide for the image data, or the like.

Using this process, a local electronic picture frame can have its image data or operational data modified by a remote device. This can increase the utility of an electronic picture frame to a user who is not technically adept by allowing a remote user (e.g., a friend or family member who is more technically adept) to update the electronic picture frame as new image data becomes available (i.e., as new pictures get taken).

Local Electronic Picture Frame Updating Remote Electronic Picture Frame

One specific example of how information in an electronic picture frame can be updated is by having one electronic picture frame (e.g., a local electronic picture frame) update another electronic picture frame (e.g., a remote electronic picture frame). This can provide for a convenient means up the operator of the local electronic picture frame to update the remote electronic picture frame. The operator of the local electronic picture frame can maintain and update their pictures, and then simply contact the remote electronic picture frame to copy in whole or in part the images and instructions contained in the local device.

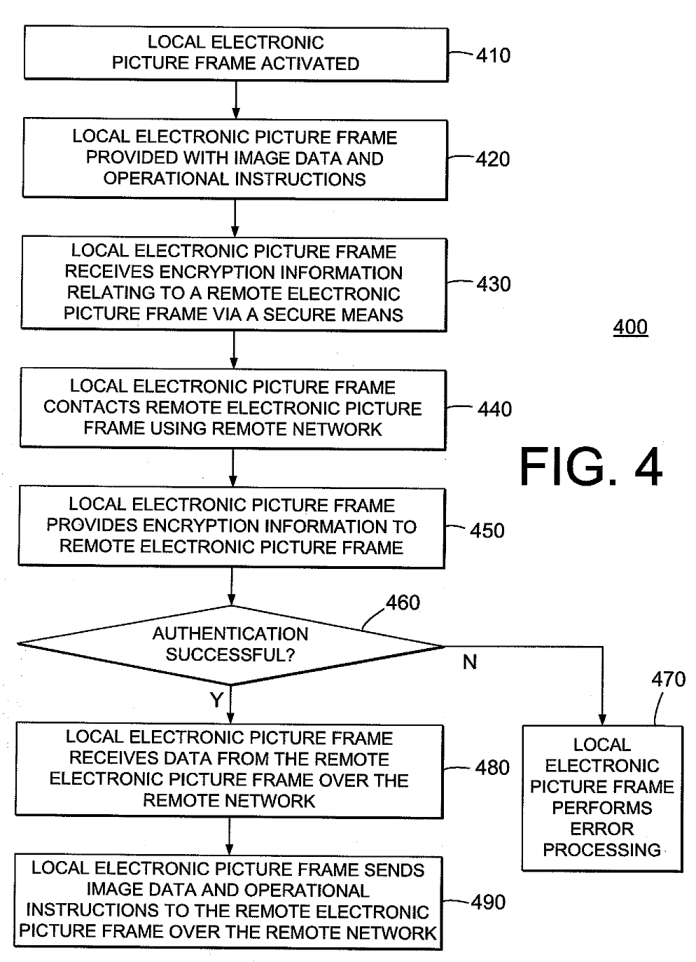

FIG. 4 is a flow chart showing a process of a local electronic picture frame updating a remote electronic picture frame according to disclosed embodiments. As shown in FIG. 4, the process 400 begins when the local electronic picture frame is activated (410).

The local electronic picture frame is then provided with image data and operational instructions (420). Although this operation refers to “image data,” the data can actually include static image data, video image data, audio data, or anything else that could be displayed at a local or remote electronic picture frame.

In addition, although this operation also refers to the local electronic picture frame being provided with image data and operational instructions, in some situations it may only receive one or the other. However, the operation can proceed in the same manner whether the local electronic picture frame is then provided with only image data, only operational instructions, or both image data and operational instructions.

The local electronic picture frame also receives encryption information relating to a remote electronic picture frame via some kind of secure means (430). This could involve receiving a secure encryption key during a face-to-face meeting, receiving the encryption information from a trusted remote third party that authenticates both devices, or any known way of securely providing encryption information.

And although FIG. 4 shows that the operation of receiving the encryption information is shown taking place after the local electronic picture frame receives the image data and operational instructions, this operation can occur either before or after the receipt of such data and instructions.

Once it receives the encryption information, the local electronic picture frame contacts a remote electronic picture frame using a remote network (440), and provides the encryption information to the remote electronic picture frame (450). The remote network could be a telephone network, the Internet, or any other suitable remote network.

The remote electronic picture frame will then use this information to authenticate the local electronic picture frame. And based on this authentication operation, the local electronic picture frame will be informed as to whether the authentication process was successful (460). This can occur by the local electronic picture frame receiving a communication from the remote electronic picture frame directly indicating either success or failure. Alternatively, if authentication fails, it may simply involve the lapse of a certain amount of time without an active authentication acknowledgement.

If the authentication is not successful, then the local electronic picture frame performs some sort of error processing (470). This can include storing information regarding the authentication failure in a memory element, displaying information regarding the authentication failure on a display element, or the like. This error processing may provide the user of the local electronic picture frame with reasons for the failure to authenticate, and may also offer an opportunity to correct these errors and reauthenticate. For example, the error may have been due to incorrectly entered encryption information. And the user of the local electronic picture frame may be prompted to check the accuracy of the encryption information and try again.

In the case of correction reauthentication, the local electronic picture frame could return to the operations of contacting the remote electronic picture frame (440) and providing encryption information (450) after an error correction operation is performed.

If the authentication operation is successful, however, then the local electronic picture frame receives data from the remote electronic picture frame (480) and may then send image data and operational instructions to the remote electronic picture frame over the remote network (490). The information the local electronic picture frame receives may include routing information, an indication of current stored images or current operational instructions, information relating to the physical parameters of the remote electronic picture frame, or the like.

As noted above, the image data may actually include static image data, video image data, audio data, or anything else that could be displayed at a local or remote electronic picture frame. Also, while the local electronic picture frame may send image data and operational instructions, it may also send only one or the other in some situations.

By this process, the user of a local electronic picture frame can share image data and operational instructions with one or more remote devices. This can simplify the sharing of data between two parties by allowing one user to copy all or part of what is stored on one electronic picture frame onto a remote electronic picture frame. For example, a person might load a set of new pictures onto their own electronic picture frame, and then share those pictures with a remote electronic picture frame owned by their parents. In this way the parents get a new set of pictures without having to make any additional effort.

### CONCLUSION

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed:

1. An electronic picture frame, comprising:
a controller configured to control operation of the electronic picture frame;
a memory element configured to store current image data and current operational instructions;
a display element configured to display the current image data in accordance with the current operational instructions; and
a remote wireless network interface configured to wirelessly connect the controller to a remote network that extends beyond five hundred yards from the electronic picture frame.

2. The electronic picture frame of claim 1, wherein the remote network is a cellular telephone network.

3. The electronic picture frame of claim 1, wherein the remote network is the Internet.

4. The electronic picture frame of claim 1, wherein the controller is further configured to perform an authentication operation to authenticate a remote device contacted over the remote network.

5. The electronic picture frame of claim 4, wherein the authentication operation is performed by contacting a remote trusted authorization source via the remote network.

6. The electronic picture frame of claim 4, wherein the authentication operation is performed using a public-private encryption key pair.

7. The electronic picture frame of claim 1, wherein the controller is further configured to receive at least one of new digital multimedia data, new operational instructions, and new information related to a core operating functionality of the controller from the remote device contacted over the remote network, via the remote network interface, and to store the at least one of the new digital multimedia data, the new operational instructions, and the new information related to the core operating functionality of the controller, to replace at least one of current digital multimedia data, current operational instructions, and current information related to the core operating functionality of the controller.

8. A method of operating a local electronic picture frame, comprising:
providing the local electronic picture frame with encryption information;
wirelessly receiving a communication request from a remote device through a remote network;
authenticating the remote device based on the encryption information;
wirelessly receiving update information from the remote device through the remote network, if the authenticating of the remote device is successful; and
performing an invalid request operation, if the authenticating of the remote device is not successful.

9. The method of claim 8,
wherein the update information includes new image data,
the method further comprising:
storing the new image data in a memory element; and
displaying the new image data on a display element.

10. The method of claim 8,
wherein the update information includes operational instructions,
the method further comprising:
storing the operational instructions in a memory element; and
displaying image data on a display element based on the operational instructions.

11. The method of claim 8,
wherein the update information includes instructions to delete old image data,
the method further comprising:
deleting the old image data from a memory element in accordance with the instructions to delete; and
displaying remaining image data from the memory element on a display element.

12. The method of claim 8, wherein the invalid request operation includes at least one of: storing information regarding the remote device in a memory element, and notifying a user of the local electronic picture frame of the unsuccessful authenticating of the remote device.

13. The method of claim 8, wherein the authenticating of the remote device is performed by having the local electronic picture frame wirelessly contact a remote trusted source through the remote network, the remote trusted source performing an authentication procedure based on the encryption information.

14. The method of claim 8, wherein the encryption information is a public-private encryption key pair.

15. The method of claim 8, wherein the remote network is a cellular telephone network.

16. The method of claim 8, wherein the remote network is the Internet.

17. A method of operating a local electronic picture frame, comprising:
receiving picture frame update information;
receiving encryption information;
wirelessly sending a communication request to a remote electronic picture frame through a remote network;
wirelessly receiving an authentication message from the remote electronic picture frame through the remote network; and
wirelessly sending the frame update information to the remote electronic picture frame through the remote network after receiving the authentication message.

18. The method of claim 17, wherein the picture frame update information includes at least one of: new image data, operational instructions, and instructions to delete old image data.

19. The method of claim 17, wherein the encryption information is a public-private encryption key pair.

20. The method of claim 17, wherein the remote network is a cellular telephone network.

21. The method of claim 17, wherein the remote network is the Internet.
